(19) United States
(12) Patent Application Publication
(10) Pub. No.: US 2009/0035503 A1
(43) Pub. Date: Feb. 5, 2009

(54) MULTILAYER STRUCTURE BASED ON RUBBER AND ON A GRAFT POLYAMIDE BLOCK COPOLYMER, AND ITS USE AS TUBES FOR CONDITIONED AIR AND COOLING CIRCUITS

(75) Inventors: Franck Bertoux, Montreal (CA); Martin Baumert, Dossenheim (DE); Mehdi M. Emad, Collegeville, PA (US); Jean-Jacques Flat, Goupillieres (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/088,320

(22) PCT Filed: Sep. 29, 2006
(86) PCT No.: PCT/FR2006/050961

§ 371 Date: Aug. 15, 2008

Related U.S. Application Data
(60) Provisional application No. 60/735,229, filed on Nov. 9, 2005.

(30) Foreign Application Priority Data
Sep. 30, 2005 (FR) 0509988

(51) Int. Cl. B32B 1/08; B32B 27/34

(52) U.S. Cl. 428/36.8; 428/474.4; 428/475.5

(57) ABSTRACT

The present invention relates to a multilayer structure based on rubber and on polyamide-block graft copolymer, comprising in succession:
a) optionally a first, inner layer (1) formed of a rubber or of a polyamide,
b) at least one layer (2) based on a polyamide-block graft copolymer composed of a polyolefin backbone and at least one polyamide graft, wherein the grafts are attached to the backbone by the residues of an unsaturated monomer (X) having a function which is capable of reacting with an amine-terminated polyamide, the residues of the unsaturated monomer (X) being attached to the backbone by grafting or copolymerization via its double bond,
c) a second layer (3) formed of a rubber,
d) optionally a binder layer (4),
e) an outer layer (5) formed of a rubber,
f) optionally a reinforcing layer situated between two of the preceding layers or within said layers.

One advantageous use of this structure relates to tubes for transporting refrigerant fluids of CO₂ or HFA type in conditioned-air circuits, more particularly for automobiles, and the transport of automobile engine cooling liquids.

The present invention relates to a multilayer structure based on rubber and on polyamide-block graft copolymer, comprising various successive layers of materials which differ in nature in order to give them enhanced thermomechanical properties; this structure finds preferential use, in particular, for the manufacture of primarily elastomeric multilayer tubes comprising at least one barrier layer, which are particularly appropriate for transporting fluids or gases for conditioned-air circuits, and fluids for cooling circuits.

These tubes have a composition predominantly of rubber; the term rubber as used throughout the present application denotes any vulcanized elastomeric material, such as natural rubber or latex, and also synthetic rubbers, more particularly ethylene-propylene rubber (EPR) elastomers, ethylene-propylene-diene (EPDM) elastomers, chloroprene (CR), styrene-butadiene rubber (SBR), nitrile rubber, butyl rubber, polybutadiene, epoxide rubbers, etc. These tubes are intended particularly for the transport of refrigerant or refrigerating fluids or gases, such as CO₂ and hydrofluoroalkanes (HFA), especially in conditioned-air distribution circuits for the automobile industry, or in construction.

These distribution circuits generally include a high-temperature (approximately 135° C.) and high-pressure (approximately 20 bars) line and one or more low-temperature and low- or high-pressure lines.

Another particularly useful utility concerns tubes for the cooling circuits of internal-combustion engines such as the engines of automobiles or trucks. The cooling liquids are generally aqueous solutions of alcohols such as ethylene glycol, diethylene glycol or propylene glycol, for example. These tubes are also required to have high mechanical strength and to resist the engine environment (temperature, possible presence of oil).

### PRIOR ART

For this use it is known to use thermoplastic resins based on polyamide (PA) and copolyamides, especially of type PA-6, PA 6,6 and PA6/6.6, such as the Zytel® resins from Du Pont; however, these polyamide resins have a thermal resistance (thermal aging) which is inadequate for the intended applications.

The document DE 92 03 865 U1 describes a high-pressure tube for fluid or gaseous media which comprises a pressure-resistant outer casing and an inner part consisting of two or more layers of polyamide 6 or 12, intercalated between which layers is a layer of functionalized polypropylene or a layer of partially saponified ethylene vinyl acetate copolymer (EVOH); this tube is used more particularly for the transport of Freon gas.

The document WO 02/28959 describes a polyamide-block graft copolymer on a polyolefin backbone which is selected from ethylene/maleic anhydride and ethylene alkyl(meth)acrylate/maleic anhydride copolymers, forming a nanostructured cocontinuous blend; this endows this polymer with exceptional thermomechanical properties, which are retained when redispersing this graft copolymer in flexible polyolefins such as the flexible ethylene polymers.

Blends of this kind find applications as adhesives, films, tarpaulins, calendered products, electrical cables or powders for molding processes (slush molding).

The applicant has surprisingly succeeded, by combining at least one layer of a polyamide-block graft copolymer with layers of rubber, in obtaining a multilayer structure which exhibits excellent stability and thermal resistance to 200° C., with mechanical properties which are substantially unchanged after aging to said temperature, while exhibiting low permeability to refrigerant fluids or to cooling liquids.

The original and advantageous properties of the invention relative to the state of the art, by incorporating at least one layer of polyamide-block graft copolymer into a multilayer structure, are as follows:
the combination of thermal stability, stability to hydrolysis, and thermoplastic convertibility;
better heat resistance than the PA resins used to date;
better flexibility (without addition of plasticizers), offering better performance levels in terms of reducing vibrations and noise, and of buckling resistance;
the enhancement of the impermeability to refrigerant gases or fluids, such as CO₂ and hydrofluoroalkanes (HFA), more particularly R134a, which are sold under the brand name Forane® by Arkema, relative to structures entirely of rubber.

The barrier properties of the resulting tubes to these fluids may be enhanced by adding nanofillers to the base layers of thermoplastic compositions of the invention, said nanofillers being, more particularly, exfoliable organophilic clays of lamellar type such as silicates (for example, the Nanomer® clays from Nanocor), which following complete dispersion are of nanometric size (“nanoclays”), or by adding one or more layers of other known barrier materials, such as, more particularly, partially saponified vinyl acetate-ethylene copolymers (EVOH).

The use of nanofillers in one or more of the layers of the above multilayer structures, especially for manufacturing tubes, also makes it possible to enhance the tubes' mechanical characteristics, such as, more particularly, the bursting pressure strength.

The present invention relates to a multilayer structure based on rubber and on polyamide-block graft copolymer, comprising in succession:
a) optionally a first, inner layer (1) formed of a rubber or of a polyamide,
b) at least one layer (2) based on a polyamide-block graft copolymer composed of a polyolefin backbone and at least one polyamide graft, wherein the grafts are attached to the backbone by the residues of an unsaturated monomer (X) having a function which is capable of reacting with an amine-terminated polyamide, the residues of the unsaturated monomer (X) being attached to the backbone by grafting or copolymerization via its double bond,
c) a second layer (3) formed of a rubber,
d) optionally a binder layer (4),
e) an outer layer (5) formed of a rubber,
f) optionally a reinforcing layer (6) situated between two of the preceding layers or within said layers.

According to the invention the multilayer structure comprises a second layer (2′) based on a polyamide-block graft copolymer, this layer being disposed between the layer (2) and a barrier-material layer (6), such as, more particularly, a partially saponified ethylene-vinyl acetate copolymer (EVOH).

The multilayer structure advantageously further comprises at least one polyamide layer (7).

However, the layers (2) and (2′) may be intercalated between two polyamide layers (7) or between one polyamide layer (7) and one rubber layer or between one polyamide layer (7) and one other barrier layer.

In this multilayer structure the layers (2) and (2′) based on a polyamide-block graft copolymer preferably further comprise nanofillers.

However, the other layers may also include nanofillers.

Preferably, X is an unsaturated carboxylic acid anhydride, and the polyolefin backbone containing X is selected from ethylene-maleic anhydride and ethylene-alkyl (meth)acrylate-maleic anhydride copolymers.

Moreover, according to the invention, the polyamide grafts are mono-NH₂ polyamide 6 or mono-NH₂ copolyamide 6/11 grafts.

Moreover, in the thermoplastic composition, the polyamide grafts have a molar mass of between 1000 and 5000 g/mol.

According to one preferred embodiment of the invention the layers (2) and (2′) based on a polyamide-block graft copolymer comprise nanofillers as a mixture.

The multilayer structure preferably comprises at least one inner layer and one outer layer which are produced from rubber; moreover, it may comprise an additional barrier layer, more particularly of partially saponified ethylene-vinyl acetate copolymer (EVOH) or of polyamide.

According to one variant embodiment, certain layers making up said multilayer structure are joined to one another by a binder layer.

A binder is any product which allows the different layers to adhere to one another, and more particularly to layers of elastomer, such as rubber. It is possible to use all of the products which are known as coextrusion binders of these materials.

These binders are selected advantageously from functionalized polyolefins, blends with a PA matrix and a polyolefin dispersed phase, or copolyamides.

Moreover, one or more layers of the structure may be antistatic. This may be obtained more particularly by adding, to the composition of these layers, additives or fillers such as, for example, carbon black, carbon nanotubes or metallic fibers.

The reinforcing layer (6) may be made from braided fibers, more particularly of materials such as polyester or of metallic threads.

The various layers are preferably produced by coextrusion, with or without a binder layer between them, in one or more steps, in accordance with typical thermoplastics techniques, to form tubes.

These tubes may be smooth (of constant diameter) or may be annularly corrugated or may comprise annularly corrugated parts and smooth parts.

According to one preferred embodiment the invention relates to tubes for conditioned-air circuits, more particularly of automobiles, composed of the above multilayer structure, wherein the layers (2) and/or (2′) of polyamide-block graft copolymers are in an inner layer or intercalated between two layers of rubber or between one layer of rubber and one other barrier layer or between two layers of polyamide or between one layer of polyamide and one layer of rubber or between one layer of polyamide and one other barrier layer.

More particularly the fluid transported in these tubes is a refrigerant fluid such as more particularly a hydrofluoroolkane, or CO₂.

According to another embodiment the invention relates to tubes for cooling circuits, composed of the structure according to the invention, wherein the layers (2) and/or (2′) of polyamide-block graft copolymers are in an inner layer or intercalated between two layers of rubber or between one layer of rubber and one other barrier layer or between two layers of polyamide or between one layer of polyamide and one layer of rubber or between one layer of polyamide and one other barrier layer.

These cooling circuits are particularly appropriate for the cooling liquids of internal-combustion engines such as the engines of automobiles or trucks. The cooling liquids are generally aqueous solutions of alcohols such as, for example, ethylene glycol, diethylene glycol or propylene glycol.

The main constituent of the thermoplastic composition forming the layer, or one of the layers, having barrier properties, of the pipes or tubes whose use is the subject of the present invention will be described in greater detail.

As regards the polyamide-block graft copolymer, it may be obtained by reacting an amine-terminated polyamide with the residues of an unsaturated monomer X attached by grafting or copolymerization to a polyolefin backbone.

This monomer X may be, for example, an unsaturated epoxide or an unsaturated carboxylic acid anhydride. The unsaturated carboxylic acid anhydride may be selected, for example, from maleic, itaconic, citraconic, allyl succinic, cyclohex-4-ene-1,2-dicarboxylic, 4-methylene-cyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides. Advantageously maleic anhydride is used. It would not be outside the scope of the invention to replace all or some of the anhydride with an unsaturated carboxylic acid such as, for example, (meth)acrylic acid.

Examples of unsaturated epoxides are as follows:
aliphatic glycidyl esters and ethers such as allyl glycidyl ether, vinyl glycidyl ether, glycidyl maleate and itaconate, glycidyl acrylate and methacrylate, and
alicyclic glycidyl esters and ethers such as 2-cyclohexene-1-glycidyl ether, cyclohexene-4,5-diglycidyl carboxylate, cyclohexene-4-glycidyl carboxylate, 5-norbornene-2-methyl-2-glycidyl carboxylate, and endocis-bicyclo(2.2.1)-5-heptene-2,3-diglycidyl dicarboxylate.

As regards the polyolefin backbone, a polyolefin is defined as a homopolymer or copolymer of alpha-olefins or diolefins, such as for example ethylene, propylene, 1-butene, 1-octene or butadiene. By way of example, mention may be made of:
homopolymers and copolymers of polyethylene, in particular LDPE, HDPE, LLDPE (linear low density polyethylene), VLDPE (very low density polyethylene) and metallocene polyethylene;
homopolymers or copolymers of propylene;
ethylene/alpha-olefin copolymers such as ethylene/propylene copolymers, EPRs (ethylene-propylene rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers; and
copolymers of ethylene with at least one product selected from salts or esters of unsaturated carboxylic acids such as alkyl(meth)acrylate (for example, methyl acrylate), or vinyl esters of saturated carboxylic acids such as vinyl acetate, the proportion of comonomer possibly reaching 40% by weight.

Advantageously the polyolefin backbones to which the X residues are attached are polyethylenes grafted with X or copolymers of ethylene and X that are obtained, for example, by radical polymerization.

As regards the polyethylenes onto which X will be grafted, polyethylene is understood to mean homopolymers or copolymers.

As comonomers, mention may be made of:
alpha-olefins, advantageously those having from 3 to 30 carbon atoms. Examples have been mentioned above. These alpha-olefins may be used alone or as a blend of two or more than two;
esters of unsaturated carboxylic acids such as for example alkyl(meth)acrylates, the alkyl groups possibly having up to 24 carbon atoms; examples of alkyl acrylates or methacrylates are especially methyl methacrylate, ethyl acrylate, n-butyl acrylate, isobutyl acrylate and 2-ethylhexyl acrylate;
vinyl esters of saturated carboxylic acids such as for example vinyl acetate or vinyl propionate;
dienes such as for example 1,4-hexadiene; and
the polyethylene may comprise two or more of the preceding comonomers.

Advantageously the polyethylene, which may be a blend of two or more polymers, comprises at least 50% and preferably 75% (in moles) of ethylene; its density may be between 0.86 and 0.98 g/cm³. The MFI (melt flow index at 190° C., 2.16 kg) is advantageously between 20 and 1000 g/10 min.

As examples of polyethylenes, mention may be made of:
low density polyethylene (LDPE);
high density polyethylene (HDPE);
linear low density polyethylene (LLDPE);
very low density polyethylene (VLDPE);
polyethylene obtained by metallocene catalysis;
EPR (ethylene-propylene rubber) elastomers;
EPDM (ethylene-propylene-diene) elastomers;
blends of polyethylene with an EPR or an EPDM; and
ethylene/alkyl(meth)acrylate copolymers possibly containing up to 60% by weight of (meth)acrylate and preferably 2 to 40%.

Grafting is an operation known per se.

As regards copolymers of ethylene and X, i.e. those in which X is not grafted, these are copolymers of ethylene, of X and optionally of another monomer which may be selected from the comonomers that were mentioned above for the ethylene copolymers intended to be grafted.

Advantageously the ethylene-maleic anhydride and ethylene-alkyl (meth)acrylate-maleic anhydride copolymers are used. These copolymers comprise from 0.2 to 10% by weight of maleic anhydride, from 0 to 40% and preferably 5 to 40% by weight of alkyl(meth)acrylate. Their MFI is between 5 and 100 (measured at 190° C. under a load of 2.16 kg). The alkyl(meth)acrylates have already been described above. The melting temperature is between 60 and 120° C.

Advantageously there are on average at least two moles of X per chain attached to the polyolefin backbone and preferably from 2 to 5. A person skilled in the art may easily determine the number of these moles of X by FTIR analysis. For example, if X is maleic anhydride and the polyolefin backbone has a weight-average molecular mass M_{w}=95 000 g/mol, it has been found that this would correspond to a proportion of anhydride of at least 1.5% by weight of the whole polyolefin backbone containing X, preferably from 2.5 to 4%. These values, combined with the weight of the amine-terminated polyamides, determine the proportion of polyamide and of backbone in the polyamide-block graft copolymer.

As regards the amine-terminated polyamide, the term “polyamide” is understood to mean the condensation products of:
one or more amino acids, such as aminocaproic, 7-aminoheptanoic, 11-aminoundecanoic and 12-aminododecanoic acids, with one or more lactams such as caprolactam, enantholactam and lauryllactam;
one or more salts or mixtures of diamines such as hexamethylenediamine, dodecamethylenediamine, meta-xylylenediamine, bis-p-aminocyclohexylmethane and trimethylhexamethylenediamine with diacids such as isophthalic, terephthalic, adipic, azelaic, suberic, sebacic and dodecanedicarboxylic acids; or
blends of two or more monomers, resulting in copolyamides.

Blends of polyamides may be used. Advantageously PA 6, PA 11, PA 12, the copolyamide having 6 units and 11 units (PA 6/11), the copolyamide having 6 units and 12 units (PA 6/12) and the copolyamide based on caprolactam, hexamethylenediamine and adipic acid (PA 6/6-6) are used. The advantage of the copolyamides is that it is thus possible to select the melting temperature of the grafts.

The degree of polymerization may vary within large proportions; depending on its value, the product is a polyamide or a polyamide oligomer. In the remainder of the text either one of the two expressions will be used for the grafts.

So that the polyamide has a monoamine termination, it is sufficient to use a chain stopper of formula:

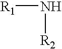

in which:

R₁ is hydrogen or a linear or branched alkyl group containing up to 20 carbon atoms; and
R₂ is a linear or branched, alkyl or alkenyl group having up to 20 carbon atoms, a saturated or unsaturated cycloaliphatic radical, an aromatic radical or a combination of the above. The stopper may be, for example, laurylamine or oleylamine.

Advantageously the amine-terminated polyamide has a molar mass of between 1000 and 5000 g/mol and preferably between 2000 and 4000.

The amino acid or lactam monomers preferred for the synthesis of the monoamine oligomer according to the invention are selected from caprolactam, 11-aminoundecanoic acid or dodecalactam. The preferred monofunctional polymerization stoppers are laurylamine and oleylamine.

The polycondensation defined above is carried out according to commonly known methods, for example at a temperature generally between 200 and 300° C., under vacuum or in an inert atmosphere, with stirring of the reaction mixture. The average chain length of the oligomer is determined by the initial molar ratio of the polycondensable monomer or the lactam to the monofunctional polymerization stopper. To calculate the average chain length, one molecule of chain stopper is usually counted per one oligomer chain.

The addition of the polyamide monoamine oligomer to the polyolefin backbone containing X is carried out by reaction of one amine function of the oligomer with X. Advantageously X bears an anhydride or acid function, and so amide or imide bonds are created.

The addition of the amine-terminated oligomer to the polyolefin backbone containing X is preferably carried out in the melt state. Thus the oligomer and the backbone can be kneaded, in an extruder, at a temperature generally between 230 and 280° C. The average residence time of the molten material in the extruder may be between 15 seconds and 5 minutes, and preferably between 1 and 3 minutes. The efficiency of this addition is evaluated by selective extraction of the free polyamide oligomers, i.e., those that have not reacted to form the final polyamide-block graft copolymer.

The proportions of polyolefin backbone containing X (abbreviated PO) and amine-terminated polyamide (abbreviated PA) are such that PO/PA is between 55/45 and 90/10 and advantageously between 60/40 and 80/20.

The preparation of such amine-terminated polyamides and also their addition to a polyolefin backbone containing X is described in U.S. Pat. No. 3,976,720, U.S. Pat. No. 3,963,799, U.S. Pat. No. 5,342,886 and FR 2 291 225.

The polyamide-block graft copolymers used in the thermoplastic compositions according to the present invention are characterized by a nanostructured arrangement with polyamide lamellae having a thickness of between 10 and 50 nanometers.

These copolymers have very good creep resistance at temperatures at least equal to 80° C. and possibly ranging up to 130° C., which is to say that they do not break under 25 kPa.

The copolymers used in the invention may be prepared by melt-blending in extruders (single-screw or twin-screw), Buss kneaders, Brabender mixers and, in general, the usual devices for blending thermoplastics, and preferably in twin-screw extruders.

The thermoplastic compositions used according to the invention may also comprise fluidifying agents such as silica, ethylenebisamide, calcium stearate or magnesium stearate. They may also comprise heat stabilizers, antioxidants, UV stabilizers, mineral fillers and coloring pigments.

The compositions of the invention may be prepared in one step in an extruder. In the first zones, the backbone containing X (for example an ethylene-alkyl (meth)acrylate-maleic anhydride copolymer) and the amine-terminated polyamide are introduced, then, several zones later, the additives are introduced. It is also possible to introduce all the ingredients into the first zone of the extruder.

### DESCRIPTION OF EXEMPLARY EMBODIMENTS OF THE INVENTION

Three thermoplastic compositions A, B and C, being in the form of a co-continuous nanostructured blend, are produced from the following components, whose amounts, in parts by weight, are given in Table 1 below:

TABLE 1

| | A | B | C |
|---|---|---|---|
| LOTADER 4700 | 80 | | |
| LOTADER 7500 | | 80 | |
| LOTADER 3210 | | | 80 |
| PA 6 mono NH2 | 19 | 19 | 19 |
| Irgafos 168 | 0.5 | 0.5 | 0.5 |
| Irganox 1098 | 0.5 | 0.5 | 0.5 |

LOTADER 4700 from Arkema is an ethylene-ethyl acrylate (29 wt %)-maleic anhydride (1.5 wt %) terpolymer having an MFI of 7 (g/10 min measured at 190° C. under a load of 2.16 kg, according to the standard ASTM D 1238).

LOTADER 75000 from Arkema is an ethylene-ethyl acrylate (17.5 wt %)-maleic anhydride (2.9 wt %) terpolymer having an MFI of 70.

LOTADER 32100 from Arkema is an ethylene-butyl acrylate (6 wt %)-maleic anhydride (3 wt %) terpolymer having an MFI of 5.

The mono-NH₂ PA 6 has a molecular mass of 2500 g/mol.

Irganox 1098 is an antioxidant from CIBA.

Irgafos 168 is a stabilizer from CIBA.

These components are introduced into a LEISTRITZ® LSM 306-34 co-rotating twin-screw extruder having a temperature profile between 240 and 280° C., the product obtained being bagged after granulation.

Hydrolysis resistance tests were conducted with composition A under the following conditions:

Variation of the mechanical properties after aging in water/Havoline at 130° C.; the mechanical properties of breaking stress and elongation at break are measured at −30° C.:

| | | | Aging 1000 h - 130° C. - water/Havoline | | | |
|---|---|---|---|---|---|---|
| | | | In immersion | | In vapor phase | |
| | | | Measurement | | Measurement | |
| | Test −30° C. 200 mm/s | Initial (n = 5) | (n = 2) | Variation | (n = 2) | Variation |
| Composition | Breaking stress (MPa) | 28.9 | 20.7 | −28% | 21.7 | −25% |
| A | | 0 | 0.6 | | 2.4 | |
| | Elongation at break (%) | 91 | 133 | 46% | 160 | 76% |
| | | 2 | 5 | | 43 | |

As preferred embodiments, the pipes or multilayered tubes for use according to the invention may be composed in succession, radially from the inside to the outside, of:
a layer of polyamide-block graft copolymer of composition A, B or C, a rubber layer, a reinforcing layer and a rubber cover layer;
a layer of elastomer or rubber (as defined above), a layer of polyamide-block graft copolymer of composition A, B or C, a rubber layer, a binder layer and a rubber cover layer;
a rubber layer, a layer of composition A, B or C, containing nanofillers, a rubber layer, a binder layer and a rubber cover layer;
a rubber layer, a first layer of composition A, B or C, a partially saponified ethylene-vinyl acetate copolymer (EVOH) layer, a second layer of composition A, B or C, a rubber layer, a binder layer, and a rubber cover layer;
a PA layer, a partially saponified ethylene-vinyl acetate copolymer (EVOH) layer, a layer of composition A, B or C, a rubber layer, a binder layer, and a rubber cover layer.

The various rubber layers may be composed of a single material or of different materials, selected from those given above.

The multilayer structure of the invention may comprise at least one polyamide layer, more particularly of type PA6 or PA6,6, either in the place of the first inner layer or disposed between two of the successive different layers.

One or more layers may be antistatic by virtue of the addition, more particularly, of fillers such as carbon black, metallic fibers or carbon nanotubes. The structure thus allows the dissipation of electrical charges.

At least one reinforcing layer may also be intercalated at the interface between two of the preceding layers or inside one of the layers. The reinforcement may consist, for example, of a mesh or of a braid of fibers, more particularly of materials such as polyester or metallic threads.

The thicknesses of the various layers are generally different and are adapted as a function of the specific properties desired for the resulting tubes.

As regards, more particularly, the tube for cooling circuits, it may have, for example, an inside diameter of 5 to 100 mm, an outside diameter of 8 to 250 mm, and a thickness of 1 to 10 mm. Regarding the thickness of the layers, the total thickness is advantageously 30 to 95% for layers (1), (3) or (5), 5 to 60% for layers (2) and/or (2′), and the remainder for the other layers.

As a nonlimitative example, for the tubes according to the invention, the thicknesses of the layers may range between 10 and 500 μm. The formation of these multilayer structures to produce tubes is carried out by coextrusion, with or without a binder layer between them, and in one or more steps.

Tests of permeability to the CO₂ or HFA refrigerants that are used in conditioned-air circuits for automobiles, for the various structures described, show values which are superior to those for tubes made of rubber and polyamide.

It is also possible to envision the use of the multilayer structures of the invention for tubes for the conditioned-air circuits in any type of vehicle or means of transport, and also in construction.

1. A multilayer structure comprising rubber and n polyamide-block graft copolymer, comprising in succession:
a) optionally a first, inner layer (1) formed of a rubber or of a polyamide,
b) at least one layer (2) comprising a polyamide-block graft copolymer composed of a polyolefin backbone and at least one polyamide graft, wherein the grafts are attached to the backbone by the residues of an unsaturated monomer (X) having a function which is capable of reacting with an amine-terminated polyamide, the residues of the unsaturated monomer (X) being attached to the backbone by grafting or copolymerization via its double bond,
c) a second layer (3) comprising a rubber,
d) optionally a binder layer (4),
e) an outer layer (5) comprising a rubber,
f) optionally a reinforcing layer situated between two of the preceding layers or within said layers.

2. The multilayer structure of claim 1, comprising a second layer (2′) comprising a polyamide-block graft copolymer, said layer 2′ being disposed between the layer (2) and a barrier-material layer (6).

3. The multilayer structure of claim 1, wherein one or more layers further comprise nanofillers.

4. The multilayer structure of claim 1, further comprising a polyamide layer (7).

5. The multilayer structure of claim 1, wherein at least one of the layers comprises additives which permit the dissipation of electrical charges.

6. The multilayer structure of claim 1, wherein X is an unsaturated carboxylic acid anhydride.

7. The multilayer structure of claim 1, wherein the polyolefin backbone containing X is selected from ethylene-maleic anhydride and ethylene-alkyl(meth)acrylate-maleic anhydride copolymers.

8. The multilayer structure of claim 1, wherein the polyamide grafts are mono-NH₂ polyamide 6 or mono-NH₂ copolyamide 6/11.

9. The multilayer structure of claim 1, wherein said structure comprises a tube for conditioned-air circuits, wherein the layers (2) and/or (2′) of polyamide-block graft copolymers are in an inner layer, or intercalated between two layers of rubber, or between one layer of rubber and one other barrier layer, or between two layers of polyamide, or between one layer of polyamide and one layer of rubber, or between one layer of polyamide and one other barrier layer.

10. The multilayer structure of claim 10, wherein said structures are tubes transporting a refrigerant fluid.

11. The multilayer structure of claim 1, wherein said structure comprises a tube for the cooling circuits of internal-combustion engines, wherein the layers (2) and/or (2′) of polyamide-block graft copolymers are in an inner layer or intercalated between two layers of rubber or between one layer of rubber and one other barrier layer or between two layers of polyamide or between one layer of polyamide and one layer of rubber or between one layer of polyamide and one other barrier layer.

12. The tubes of claim 11, wherein the fluid transported is a cooling liquid in the form of aqueous solutions of alcohols such as ethylene glycol, diethylene glycol or propylene glycol.

13. The multilayer structure of claim 2, wherein said layer layer 2′ comprises a partially saponified ethylene-vinyl acetate copolymer (EVOH).

14. The multilayer structure of claim 9, wherein said tube for conditioned-air circuits is a tube for an automobile conditioned-air circuit.

15. The multilayer structure of claim 10, wherein said a refrigerant fluid is hydrofluoroalkane or CO₂.
